(19) United States
(12) Patent Application Publication
(10) Pub. No.: US 2014/0060777 A1
(43) Pub. Date: Mar. 6, 2014

(54) BEVERAGE CONTAINER SLEEVE AND METHOD OF MAKING AND USING SAME

(71) Applicant: Rita Belford, Piscataway, NJ (US)

(72) Inventor: Rita Belford, Piscataway, NJ (US)

(21) Appl. No.: 13/931,466

(22) Filed: Jun. 28, 2013

Related U.S. Application Data
(63) Continuation of application No. 13/024,248, filed on Feb. 9, 2011, now abandoned.
(60) Provisional application No. 61/302,900, filed on Feb. 9, 2010.
(60) Provisional application No. 61/377,878, filed on Aug. 27, 2010.

(51) Int. Cl. A61J 9/06; F25B 29/00

(52) U.S. Cl. CPC A61J 9/06; F25B 29/00
USPC 165/64

(57) ABSTRACT

An improved cooling and/or heating system for a beverage container, a method of manufacturing the container sleeve, and a method of using the container sleeve are disclosed herein. The improved sleeve is configured to cover a beverage container and actively cool and/or heat the container while helping to maintain the temperature of the beverage once it is cooled or heated. The cover includes a flexible insulating material with a cooling and/or heating device positioned on the inner surface.

### CROSS-REFERENCE TO RELATED APPLICATIONS

This application is a continuation of U.S. patent application Ser. No. 13/024,248, filed Feb. 9, 2011, which claims benefit under 35 U.S.C. §119(e) to U.S. Provisional Application No. 61/302,900, filed on Feb. 9, 2010, and U.S. Provisional Application No. 61/377,878, filed on Aug. 27, 2010, the entireties of which are hereby incorporated by reference herein and made part of this specification.

### TECHNICAL FIELD

The disclosure relates generally to the field of beverage container covers. More specifically, aspects of the disclosure relate to an improved system that covers beverage containers to help protect a user's hand from the temperature of the container while regulating and/or maintaining the temperature of the container contents. Aspects of the disclosure also relate to an improved system that covers baby bottles and helps manage and/or maintain the temperature of the bottle contents.

### BACKGROUND

Beverage container holders or covers can be used to hold aluminum cans, such as beer or soda cans, to keep a user's hand from getting cold while enjoying the beverage. Aluminum cans are typically chilled before being placed in the cover. The container cover has been made of foams or rubbers. Logos and advertisements can be placed on these covers.

### SUMMARY OF THE DISCLOSURE

The present disclosure is an improvement on beverage container covers. The improved beverage container sleeve actively cools the contents of a beverage container while helping to maintain the temperature of the beverage once it is cooled. In other embodiments, a bottle cover actively heats or cools the contents of baby bottles while helping to maintain the temperature of the beverage. The following disclosure includes embodiments of an improved cooling and/or heating system for a beverage container, a method of manufacturing the container sleeve, and a method of using the container sleeves or covers.

The improved beverage container sleeve, as disclosed herein, is configured to cover a beverage container and actively cool or heat the container while helping to maintain the temperature of a chilled beverage after it is cooled or maintain the temperature of a warm beverage after it is heated.

In some embodiments, the improved beverage container sleeve includes a cover and at least one cooling device. The cover can have multiple cutouts positioned on the inner surface for receiving the cooling devices. In one embodiment, the cover has three cutouts for receiving the cooling devices. Other embodiments can have more or less than three cutouts. In a preferred embodiment, there are four cutouts to accept four cooling devices. Preferably, the cutouts are equally spaced apart from each other for best cooling.

In other embodiments, the improved beverage container sleeve, as disclosed herein, is configured to cover a baby bottle and actively cool or heat the bottle, while helping to maintain the temperature of the beverage once it is cooled or heated. Specifically, the improved beverage container sleeve includes a cover and at least one cooling and/or heating device. The cover can have multiple cutouts positioned on the inner surface for receiving the cooling and/or heating devices. Preferably, the cutouts are equally spaced apart from each other for best cooling or heating.

The cooling and/or heating devices can include gel packs, which can be placed in and chilled by a refrigerator or freezer, or heated in the microwave or stovetop. Other cooling or heating means may also be used. In some embodiments, the cooling and/or heating device is affixed to the cover. In other embodiments, the cooling and/or heating device is removable and can be cooled or heated separately from the insulating cover. The cover is preferably constructed of an insulating material. Other materials, such as plastics or metals, can also be used.

The position of cooling and/or heating devices along the inner surface of the cover can be toward the middle of the cover. In other embodiments, the cooling and/or heating device can be positioned in other parts of the cover, such as toward the base portion of the cover. In some embodiments, the cooling and/or heating device may be larger and cover substantially the entire inner surface of the cover. Preferably, the cooling and/or heating device is positioned on the inner surface of the cover so that it can come into direct contact with the beverage container for optimum cooling or heating. In some embodiments the cooling and/or heating device and container can be separated by a layer or layers of other materials.

In use, a container is placed in the cavity of the cover so that the container can come into contact with the cooling and/or heating device. The cooling and/or heating device helps cool or heat the contents of the container while the cover insulates the container. The improved beverage container sleeve can be used to insulate and cool/heat aluminum cans or baby bottles, as well as other containers, such as plastic and glass bottles.

In some embodiments, the beverage container sleeve can include a cover having an outer surface and a cavity. The cavity can have an inner surface and can be open to an end of the cover for accepting a beverage container. A net on the inner surface of the sleeve can form a pocket and a cooling/heating device can be releasably held in the pocket. The cover can be collapsible to a generally flat configuration.

In some embodiments, the beverage container sleeve can include a cover having an outer surface, an inner surface formed by a cavity and an open end for accepting a beverage container. The sleeve can also include a cooling/heating device.

In a method of using a beverage container sleeve, the method can comprise the steps of cooling or heating a cooling/heating device, mounting the cooling/heating device to a beverage container sleeve and placing a beverage container in a cavity of the beverage container sleeve.

### BRIEF DESCRIPTION OF THE DRAWINGS

The above-mentioned features and other features of the disclosure are further described below with reference to the drawings of specific embodiments. The specific embodiments shown in the drawings are intended to illustrate, but not limit the disclosure.

FIG. 1 is a top perspective view of an embodiment of a beverage container sleeve according to an embodiment of the inventions.

FIG. 2 is a top plan view of a beverage container sleeve of FIG. 1.

FIG. 3 is a cross-section side view of the beverage container sleeve of FIG. 2 taken at line 3-3.

FIG. 4 is a top perspective view of an embodiment of a beverage container sleeve according to another embodiment of the inventions.

FIG. 5 is a top plan view of a beverage container sleeve of FIG. 4 in an unassembled configuration.

FIG. 6 is a top perspective exploded view of a beverage container sleeve of FIG. 5.

FIG. 7 is a top perspective view of a beverage container sleeve of FIG. 4 in a collapsed configuration.

FIG. 8 is a top perspective view of an embodiment of a beverage container sleeve according to an embodiment of the inventions.

FIG. 9 is a top perspective view of a beverage container sleeve of FIG. 8 in an open configuration to accept a container.

### DETAILED DESCRIPTION OF SPECIFIC EMBODIMENTS

The following disclosure addresses a need for an improved beverage container sleeve that actively cools and/or heats the contents of a beverage container while helping to maintain the temperature of the beverage once it is cooled or heated. Disclosed herein are embodiments of an improved cooling and/or heating system for a beverage container, a method of manufacturing the container sleeve, and a method of using the container sleeve. The improved beverage container sleeve is configured to cover a beverage container and can actively cool and/or heat the container while helping to maintain the temperature of a chilled or heated beverage after the beverage is cooled or heated by the sleeve.

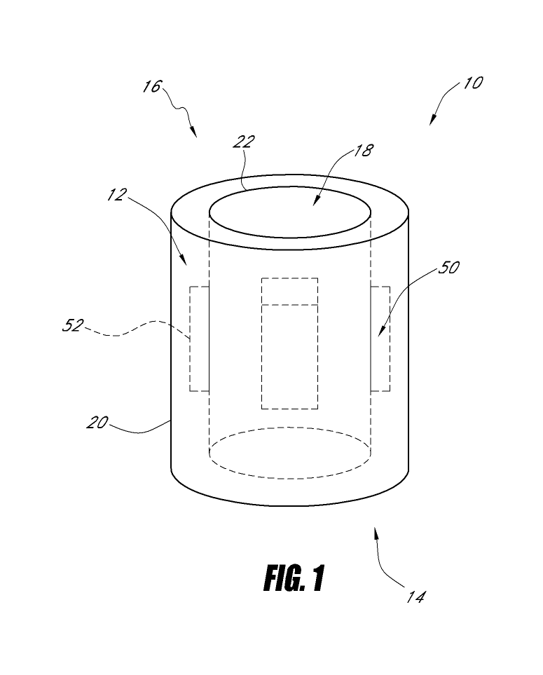

The improved beverage container sleeve 10 can include a cover 12 and a cooling device 50. As illustrated in FIG. 1, the cover 12 can have a round tubular shape with a closed end 14 and an open end 16. The inner portion of the cover 12 can have a cavity 18 that is open at the upper portion, such that the top of the cover 12 has an annular shape. The cover 12 can form an outer surface 20 and the cavity 18 can form an inner surface 22, as illustrated in FIG. 1. In alternative embodiments, the cover 12 can be open at both ends and have an annular shape at the top and bottom of the cover 12. In these embodiments, the cover 12 can have a through hole where the beverage container can be inserted.

In some embodiments, the cover 12 can include other shapes. For example, the cross sectional shape of the outer surface 20 can be oval, square or polygonal. The inner surface 22 can also include various shapes. Preferably, the inner surface 22 is cylindrical to accommodate most beverage containers. In some embodiments, the cross sectional shape of the inner surface 22 can be other shapes, such as oval, square or polygonal.

The cover 12 is preferably constructed of an insulating material. The insulating material can help to maintain the temperature of the beverage in the beverage container placed within the sleeve 10. The insulating material is preferably elastomeric such that the cavity 18 can expand and enlarge to accept various beverage containers. Furthermore, the insulating material can provide an insulation layer that provides the user with a contact surface that does not transfer heat to the beverage and is not too cold to the touch. In other embodiments, the cover 12 is constructed of other materials such as rubber, foam, plastics or metals.

In some embodiments, the cover 12 can be approximately 4 inches in height and the diameter of the outer surface 20 can be approximately 3¼ inches. The diameter of the inner surface 22 can be approximately 2½ inches. In some embodiments, the height of the cover 12 can range from approximately 2 inches to approximately 8 inches. In some embodiments, the diameter of the outer surface 20 can range from approximately 2 inches to approximately 5 inches. In some embodiments, the diameter of the inner surface 22 can range from approximately 1 inch to approximately 4 inches. In some embodiments, the height of the cover 12, diameter of the inner surface 22 and diameter of the outer surface 20 can be less than or greater than the dimensions disclosed above.

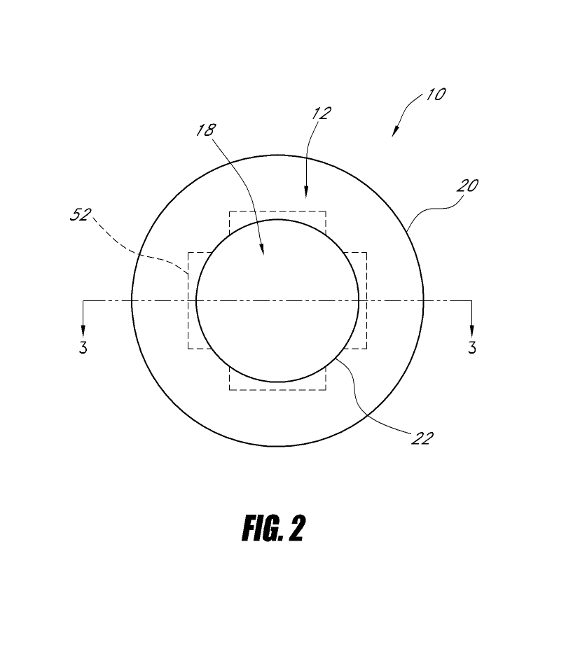

As illustrated in FIGS. 1 and 2, the cover 12 can have cutouts 52 positioned on the inner surface 22 for receiving cooling devices 50. In some embodiments, the cover 12 can have three cutouts 52 for receiving the cooling devices 50. Other embodiments can have more or less than three cutouts 52. The embodiment illustrated in FIG. 2 shows four cutouts 52 to accept four cooling devices 50. Preferably, the cutouts 52 are equally spaced apart from each other for best cooling.

The cooling devices 50 can include gel packs or ice packs. They can be placed in and chilled by a refrigerator or freezer. Other cooling means may also be used. In some embodiments, the cooling device 50 can be affixed to the cover 12 with non-releasable methods, such as adhesives or molding. In these embodiments, the cover 12 with the attached cooling device 50 can be placed in a refrigerator or freezer for cooling. In other embodiments, the cooling device 50 can be removable and can be cooled separately from the insulating cover 12. For example, the cooling device 50 and/or cover 12 can include releasable attachment means, such as reusable adhesives, to mount the cooling devices 50 to the cover 12. In other embodiments, the cutouts 52 can be dimensioned smaller than the cooling device 50 so that the cooling devices 50 can be held in the cutouts 52 by compression forces of the cover 12 on the mounted cooling devices 50. Thus, as mentioned previously, it can be advantageous for the cover 12 to be made of an elastomeric material that can help secure the cooling devices 50 to the cover 12 through elastic compression.

In some embodiments, the cooling devices 50 can be at least approximately one inch in height and at least approximately one inch in width. In some embodiments, the thickness of the cooling devices 50 is at least approximately ⅛ inch. In some embodiments, the dimensions of the cooling device 50 are configured to fit within the cover 12, as disclosed herein.

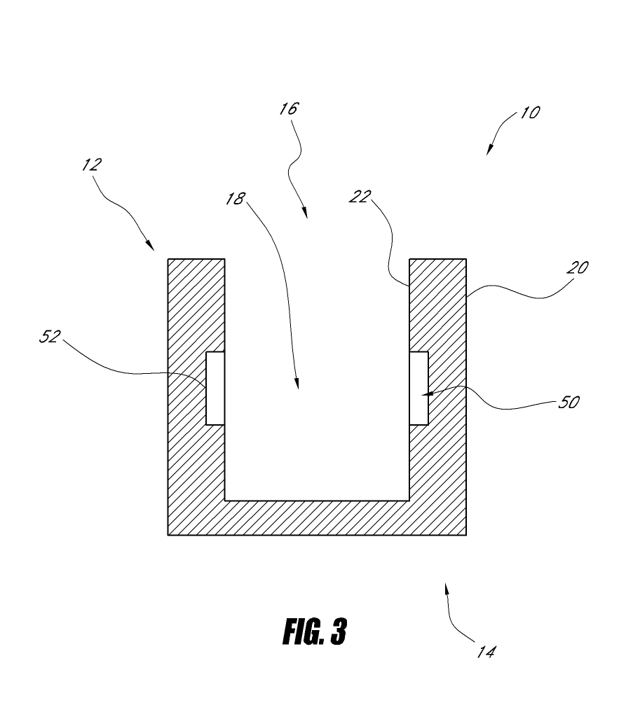

FIG. 3 illustrates cooling devices 50 positioned toward the middle height of the inner surface 22 of the cover 12. In other embodiments, the cooling device 50 may be positioned in other parts of the cover 12, such as toward the closed end 14 so that the cooling devices 50 can provide cooling even when the beverage container is almost empty. In some embodiments, the cooling devices 50 may be larger and cover 12 substantially the entire height of the inner surface 22 of the cover 12. In some embodiments, the entire inner surface 22 can be covered by the cooling devices 50.

In some embodiments, the cooling device 50 is mounted along the inner surface 22 of the cover 12 so that it can come into direct contact with the beverage container for optimum cooling and efficient transfer of heat away from the container. Mounting the cooling device 50 on the inner surface 22 can also beneficially provide a layer of insulation so that the beverage container sleeve 10 is not cold to the touch, as described above. In some embodiments, there can be a layer of material between the cooling device 50 and the container, such as when the cooling device 50 is inserted into a pocket or when a net is provided to secure the cooling device 50 within the cutout. The layer or layers of material are preferably thin in some embodiments, and can transfer heat away from the container to the cooling devices 50 for efficient cooling.

In some embodiments, the sleeve 10 can be configured to insulate and cool aluminum cans. In other embodiments, the sleeve 10 can also be configured to be used with other containers, such as for example plastic and glass bottles.

Prior to using the beverage container sleeve 10, the user can place the cooling devices 50, or the entire sleeve 10 with the cooling devices 50 mounted, into a refrigerator, freezer or other cooling means. In use, the user can remove the chilled cooling devices 50 from the cooling means and mount them (if not already mounted) to the cavities of the cover 12.

A beverage container can be placed in the cavity 18 of the cover 12 so that the container comes into contact with the cooling device 50. In preferred embodiments, the circumference of the cavity 18 is smaller than the circumference of the beverage container, so that when the container is placed in the cavity 18, a compression force holds the sleeve 10 against the container and also pushes the cooling device 50 against the container for efficient cooling. The cooling device 50 can help cool the content of the container while the cover 12 insulates the container. Preferably, the height of the beverage container is greater than the height of the sleeve 10 so that the user can drink from the top of the beverage container.

After the beverage is consumed, the user can remove the beverage container from the cavity 18 and place another beverage container in the cavity, if desired. In some embodiments, if additional cooling is desired, the user can remove the cooling devices 50 and exchange them for other chilled cooling devices 50, or place the cooling devices 50 in a cooling means to re-chill the cooling devices 50.

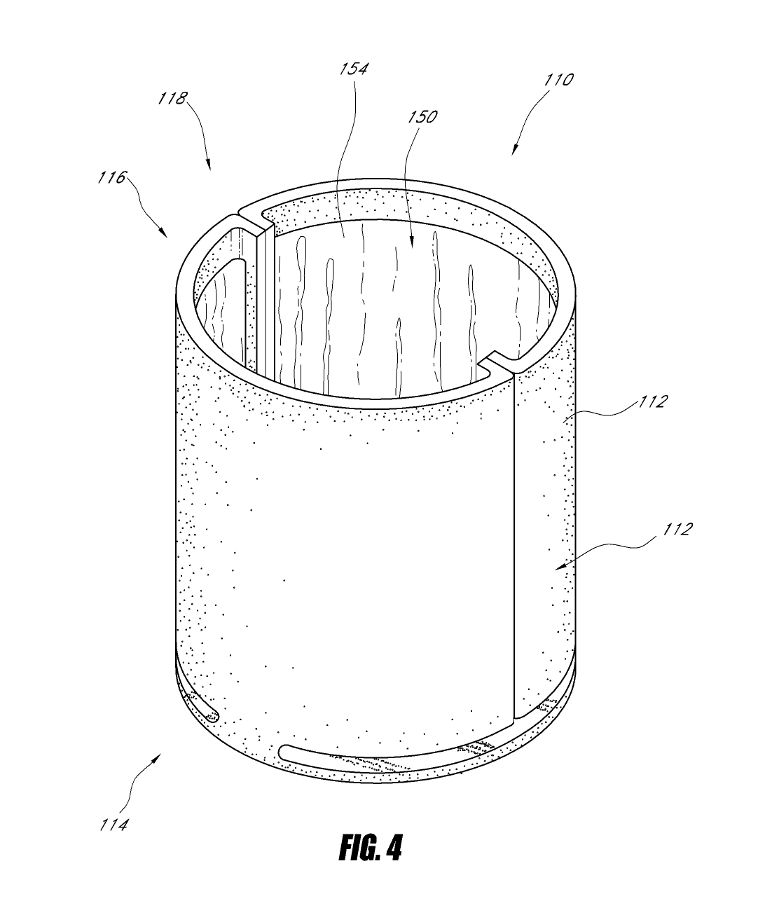

In another embodiment, the beverage container sleeve 110 can include a cover 112 that is formed from one or more pieces of material that is folded and joined along particular edges. A cooling device 150 can be coupled to the cover 112 and secured by a net 154, as illustrated in FIG. 4. The net can be made of the same material as the cover. In an expanded configuration, the container sleeve 110 can have a generally round tubular shape with a closed end 114 and an open end 116. The inner portion of the container sleeve 110 can have a cavity 118 that is open toward the open end 116. The cover 112 can form an outer surface 120 and the cavity 118 can form an inner surface 122, as illustrated in FIG. 4. In alternative embodiments, the cover 112 can be open at both ends and have a through hole where the beverage container can be inserted.

In some embodiments, the cover 112 can be flexible and can conform to any shape of beverage container. For example, the cover 112 can be fitted over a beverage container having an oval, square or polygon shaped cross-section. Furthermore, the cover 112 is preferably constructed of an insulating material. The insulating material can help to maintain the temperature of the beverage in the beverage container placed within the sleeve 110. The insulating material is preferably elastomeric such that the cavity 118 can expand and enlarge to accept various beverage container sizes. The insulating material can provide an insulation layer that provides the user with a contact surface that does not transfer heat to the beverage and is not too cold to the touch. In some embodiments, the cover 112 can be constructed of materials such as rubber, foam, plastics or metals.

In some embodiments, the container sleeve 110 can be approximately 4 inches in height and the diameter of the outer surface 120 can be approximately 3 inches when the container sleeve 110 is in the expanded configuration. The diameter of the inner surface 122 can be approximately 2¾ inches. In some embodiments, the height of the cover 112 can range from approximately 2 inches to approximately 8 inches. In some embodiments, the diameter of the outer surface 120 can range from approximately 2 inches to approximately 5 inches. In some embodiments, the diameter of the inner surface 122 can range from approximately 1 inch to approximately 4 inches. In some embodiments, the height of the cover 112, diameter of the inner surface 122 and diameter of the outer surface 120 can be less than or greater than the dimensions disclosed above.

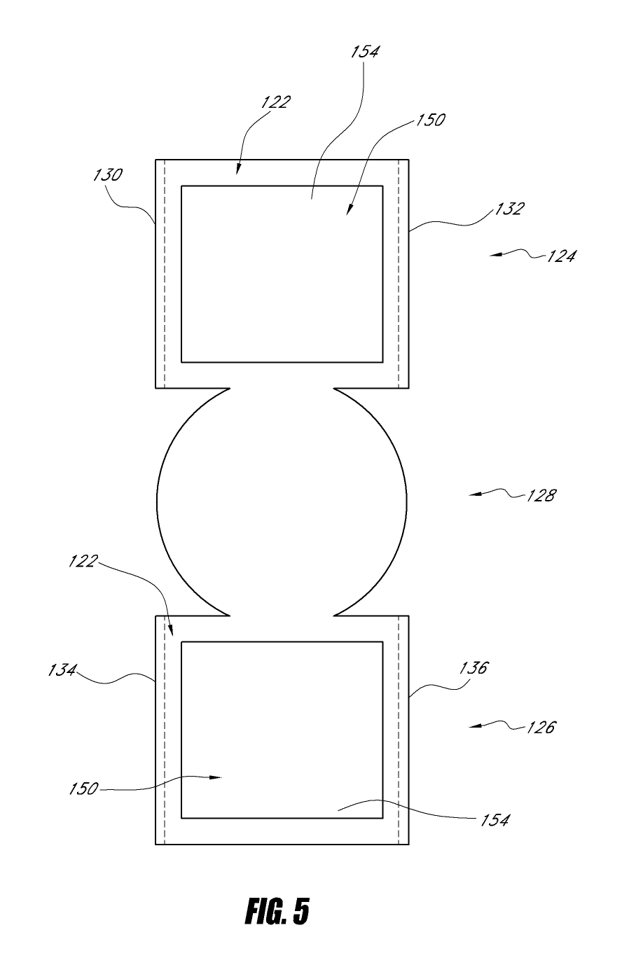

With reference to FIG. 5, the cover 112 can be made of a single piece of material. The piece of material can have a first side portion 124, a second side portion 126, and a bottom portion 128 disposed between the first and second side portions 124, 128. The first side portion 124 can have two attachment edges 130, 132 that can be coupled to the attachment edges 134, 136 of the second side portion 126, respectively. When the edges are coupled, the container sleeve 110 can form the shape illustrated for example in FIG. 4. In some embodiments, the edges can be sewn together. In some embodiments, the edges can be attached through other methods, such as adhesives, thermal bonding, fasteners, clips, rivets, etc.

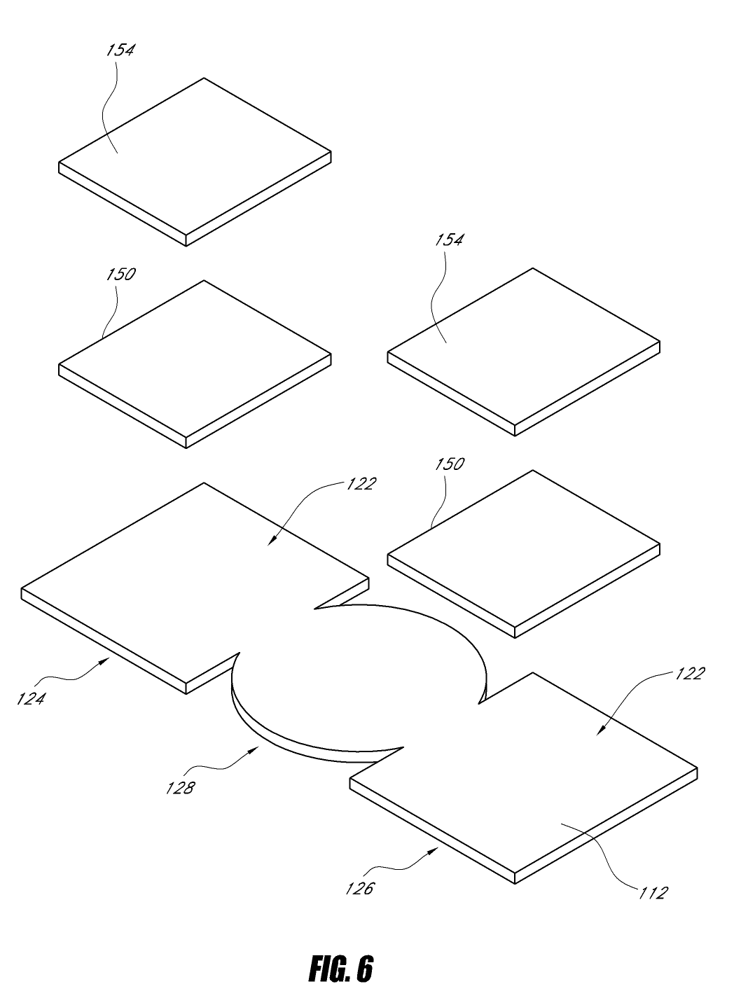

As illustrated in FIGS. 5 and 6, the cooling devices 150 can be disposed on the inner surface 122 of the cover 112. The cooling devices 150 can include gel packs or ice packs, as described above. Mounting the cooling device 150 on the inner surface 122 can beneficially provide a layer of insulation so that the beverage container sleeve 110 is not cold to the touch, as described above. In some embodiments, the cooling devices 150 can be secured to the cover 112 by a net 154. For example, the net 154 can be sewn to the cover 112 to form a pocket to contain the cooling device 150. In some embodiments, the net 154 can be sewn completely around the cooling device 150 such that the cooling device 150 is not removable from the container sleeve 110. In other embodiments, a portion of the net 154 may not be sewn to the cover 112 such that an access path is created to allow removing the cooling device 150. In some embodiments, the net 154 can be attached to the cover 112 through other methods, such as adhesives, thermal bonding, pins, zippers, buttons, rivets, etc. The attachment method can be releasable or non-releasable.

In some embodiments, the cooling device 150 can be affixed directly to the cover 112 with releasable or non-releasable methods, such as adhesives or molding. In embodiments where the cooling device 150 is non-releasaable, the container sleeve 110 with the attached cooling device 150 can be placed in a refrigerator or freezer for cooling. In other embodiments where the cooling device 150 is removable, the cooling device 150 can be cooled separately from the insulating cover 112.

The net 154 can be made of a thin material that is thermally conductive for optimum cooling and efficient transfer of heat away from the container to the cooling device 150. For example, the net 154 can be made of a metal or fabric material, such as steel fibers or nylon. In some embodiments, the net 154 can have a mesh structure with holes that allow the cooling device 150 to make direct contact with the beverage container. In some embodiments, the net 154 can be substantially solid without holes, such as an aluminum sheet.

In some embodiments, the cooling devices 150 can be approximately 3 inches in height and approximately 3½ inches in width. In some embodiments, the thickness of the cooling devices 150 can be at least approximately ⅛ inch. In some embodiments, the height of the cooling device 150 can range from approximately 1 inch to approximately 4 inches and the width can range from approximately 1 inch to approximately 4 inches.

The cooling device 150 can be positioned in any portion of the cover 112, such as toward the closed end 114 so that the cooling devices 150 can provide cooling even when the beverage container is almost empty. In some embodiments, the cooling devices 150 may be larger and cover substantially the entire height of the inner surface 122 of the cover 112. In some embodiments, the entire inner surface 122 can be covered by the cooling devices 150.

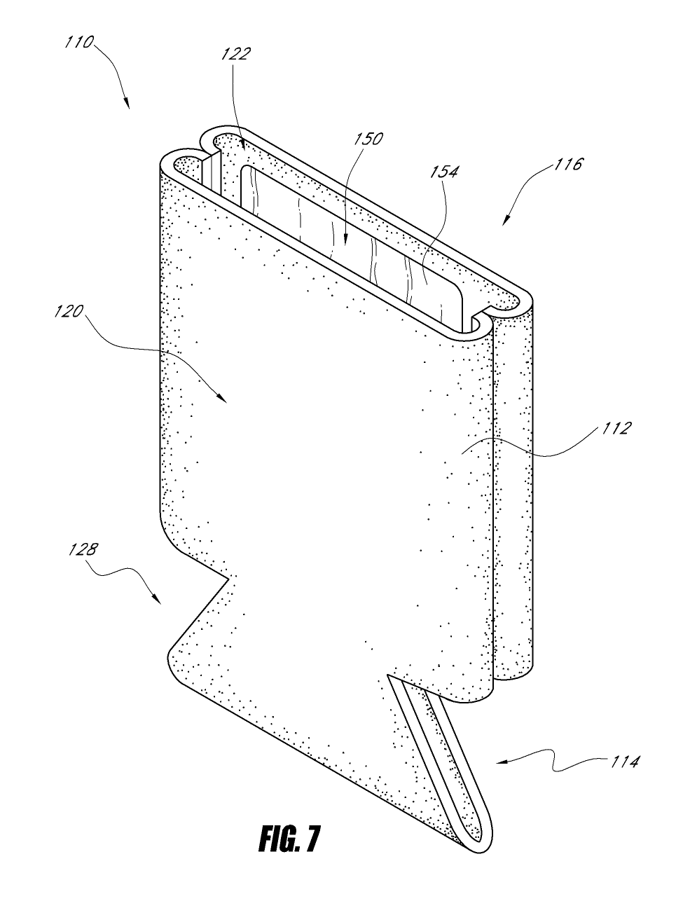

The container sleeve 110 can advantageously be collapsible, as illustrated in FIG. 7. As mentioned earlier, the cover 112 can be flexible such that the first side 124 can be adjacent the second side 126 of the container sleeve 110. The bottom portion 128 can fold and the container sleeve 110 can be generally flat. The collapsible nature of the container sleeve 110 can advantageously help in transporting and/or storing the container sleeve 110. For example, the container sleeve 110 can be collapsed and placed in a pocket for easy transport. Also, the container sleeves 110 can be collapsed and stacked on top of one another for efficient packaging, transport or storage.

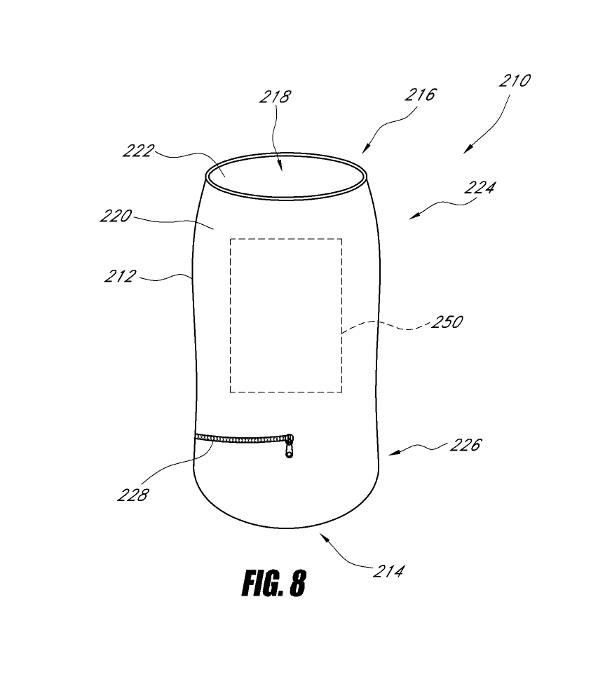

With reference to FIG. 8, in another embodiment, a bottle cover 210 can include a cover 212 that is formed from one or more pieces of material that are joined together. One or more cooling/heating devices 250 can be coupled to the cover 212 and secured by a retaining member, such as a net. In some embodiments, the net can be made of the same material as the cover 212. The bottle cover 210 can have a generally round tubular shape with a bottom end 214 and a top end 216. The inner portion of the bottle cover 210 can have a cavity 218 that is open toward the top end 216. The cover 212 can form an outer surface 220 and the cavity 218 can form an inner surface 222, as illustrated in FIG. 8. In alternative embodiments, the cover 212 can be open at both ends and have a through hole where the bottle can be inserted.

In some embodiments, the cover 212 can be flexible and can conform to any shape of container. For example, the cover 212 can be fitted over a bottle having an oval, square or polygon shaped cross-section. In some embodiments, the top end 216 can have an elastic edge so that it can stretch and conform to the shape of the container. Furthermore, the cover 212 is preferably constructed of an insulating material. The insulating material can help to maintain the temperature of the beverage in the beverage container placed within the sleeve 210. The insulating material is preferably elastomeric such that the cavity 218 can expand and enlarge to accept various beverage container sizes. The insulating material can provide an insulation layer that provides the user with a contact surface that does not transfer heat to or from the beverage and is not too cold or hot to the touch. In some embodiments, the cover 212 can be constructed of materials such as rubber, foam, plastics or metals.

In some embodiments, the bottle cover 210 can be approximately 5 inches in height and the diameter of the outer surface 220 can be approximately 2½ inches. The diameter of the inner surface 222 can be approximately 2¼ inches. In some embodiments, the height of the cover 212 can range from approximately 2 inches to approximately 8 inches. In some embodiments, the diameter of the outer surface 220 can range from approximately 2 inches to approximately 5 inches. In some embodiments, the diameter of the inner surface 222 can range from approximately 1 inch to approximately 4 inches. In some embodiments, the height of the cover 212, diameter of the inner surface 222 and diameter of the outer surface 220 can vary to accommodate a variety of different container sizes. In some embodiments, the bottle cover 210 can be adjustable to accommodate a range of different container sizes.

With reference to FIG. 8, the cover 212 can have a zipper 228 toward the lower portion of the cover 212. In the illustrated embodiment, the zipper 228 extends about half-way around the circumference of the cover 212. In other embodiments, the zipper 228 can extend generally around the entire circumference of the cover 212. In other embodiments, the zipper 228 can extend longitudinally along the cover 212 in a top-bottom direction. Although illustrated as a zipper 228, in other embodiments, the bottle cover 210 can have other forms of closure mechanisms, such as buttons, Velcro®, elastic, hooks, etc.

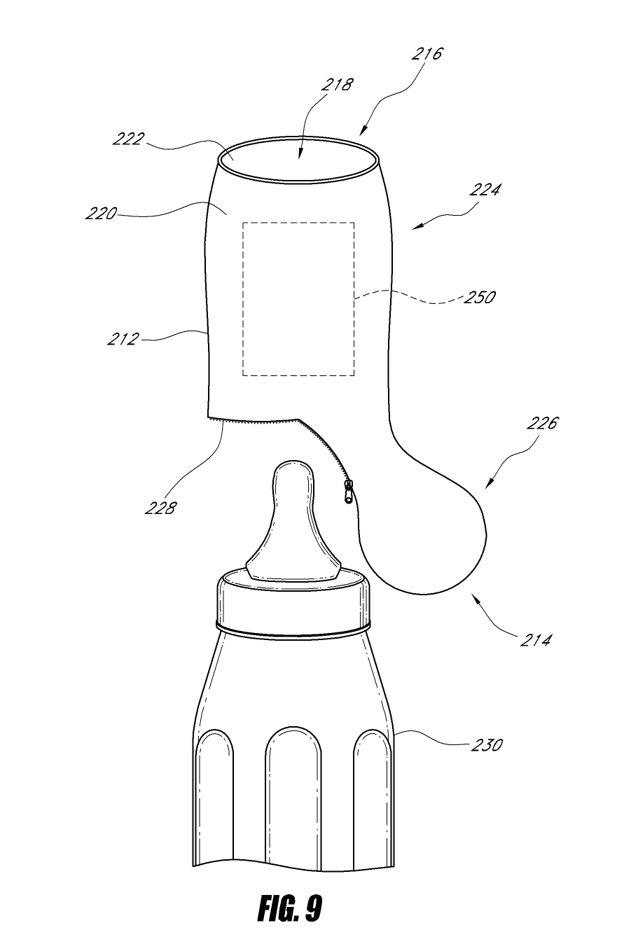

As illustrated in FIGS. 8 and 9, the cooling/heating devices 250 can be disposed on the inner surface 222 of the cover 212. The cooling/heating devices 250 can include gel packs or ice packs, as described above. Mounting the cooling/heating device 250 on the inner surface 222 can beneficially provide a layer of insulation so that the bottle cover 210 is not cold or hot to the touch, as described above. In some embodiments, the cooling/heating devices 250 can be secured to the cover 212 by a net. For example, the net can be sewn to the cover 212 to form a pocket to contain the cooling/heating device 250. In some embodiments, the net can be sewn completely around the cooling/heating device 250 such that the cooling/heating device 250 is not removable from the bottle cover 210. In other embodiments, a portion of the net may not be sewn to the cover 212 such that an access path is created to allow removing the cooling/heating device 250. In some embodiments, the net can be attached to the cover 212 through other methods, such as adhesives, thermal bonding, pins, zippers, buttons, rivets, etc. The attachment method can be releasable or non-releasable.

In some embodiments, the cooling/heating device 250 can be affixed directly to the cover 212 with releasable or non-releasable methods, such as adhesives or molding. In embodiments where the cooling/heating device 250 is non-releasaable, the bottle cover 210 with the attached cooling/heating device 250 can be placed, for example, in a refrigerator or freezer for cooling, or in the microwave or boiling water for heating. In other embodiments where the cooling/heating device 250 is removable, the cooling/heating device 250 can be cooled or heated separately from the insulating cover 212.

The net can be made of a thin material that is thermally conductive for cooling and transfer of heat away from the container to the cooling/heating device 250. For example, the net can be made of a metal or fabric material, such as steel fibers or nylon. In some embodiments, the net can have a mesh structure with holes that allow the cooling/heating device 250 to make direct contact with the beverage container. In some embodiments, the net can be substantially solid without holes, such as an aluminum sheet.

In some embodiments, the cooling/heating devices 250 can be approximately 3½ inches in height and approximately 3 inches in width. In some embodiments, the thickness of the cooling/heating devices 250 can be at least approximately ⅛ inch. In some embodiments, the height of the cooling/heating device 250 can range from approximately 1 inch to approximately 4 inches and the width can range from approximately 1 inch to approximately 4 inches.

The cooling/heating device 250 can be positioned in any portion of the cover 212, such as in the upper portion 224, as illustrated in FIGS. 8 and 9. In some embodiments, the cooling/heating device 250 can be positioned in the lower portion 226 in addition to, or instead of, the upper portion 224. Having the cooling/heating device 250 in the lower portion 226 advantageously provides cooling or heating even when the beverage container is almost empty. In some embodiments, the cooling/heating devices 250 may be larger and cover substantially the entire height of the inner surface 222 of the cover 212. In some embodiments, the entire inner surface 222 can be covered by the cooling/heating devices 250.

Prior to using the bottle cover 210, the user can place the cooling/heating devices 250, or the entire bottle cover 210 with the cooling/heating devices 250 mounted, into a refrigerator, freezer, microwave or other heating or cooling means. In use, the user can remove the chilled or heated cooling/heating devices 250 and mount them (if not already mounted) to the pockets of the cover 212.

The zipper 228 on the bottle cover 210 can be opened and a beverage container, such as a baby bottle 230, can be inserted into the cavity 218 of the cover 212 through the opening created by the open zipper, as illustrated in FIG. 9. Once the beverage container is positioned in the bottle cover 210, the zipper 228 can be closed to secure the container in the bottle cover 210. In preferred embodiments, the circumference of the cavity 218 is smaller than the circumference of the beverage container, so that when the container is placed in the cavity 218, a compression force holds the bottle cover 210 against the container and also presses the cooling/heating device 250 against the container for efficient cooling or heating. The cooling/heating device 250 can help cool or heat the content of the container while the cover 212 insulates the container. Preferably, the height of the beverage container is greater than the height of the bottle cover 210 so that the user can drink from the top of the beverage container.

After the beverage is consumed, the user can unzip the zipper 228 to remove the beverage container from the cavity 218 and place another beverage container in the cavity, if desired. In some embodiments, if additional cooling is desired, the user can remove the cooling/heating devices 250 and exchange them for other cooling/heating devices 250, or place the cooling/heating devices 250 in a cooling or heating means to re-chill or reheat the cooling/heating devices 250.

Although certain embodiments, features, and examples have been described herein, it will be understood by those skilled in the art that many aspects of the methods and devices illustrated and described in the present disclosure may be differently combined and/or modified to form still further embodiments. For example, any one component of the beverage container sleeve illustrated and described above can be used alone or with other components without departing from the spirit of the present invention. Additionally, it will be recognized that the methods described herein may be practiced in different sequences, and/or with additional devices as desired. Such alternative embodiments and/or uses of the methods and devices described above and obvious modifications and equivalents thereof are intended to be included within the scope of the present invention. Thus, it is intended that the scope of the present invention should not be limited by the particular embodiments described above, but should be determined only by a fair reading of the claims that follow.

1-20. (canceled)

21. A method of actively heating and cooling contents of a baby bottle, the method comprising:
selecting a baby bottle, the baby bottle having a nipple and a container, wherein the nipple is attached to a ring that connects the nipple to the container, wherein the container has contents to be heated or cooled,
selecting a cover configured to receive the baby bottle, wherein the cover is made of a flexible material that allows the cover to be stretched, wherein the cover has an opening for receiving the nipple of the baby bottle, wherein the cover has a gel that is secured to the cover and not removable from the cover, wherein the gel has at least two states, a heated state and a chilled state;
preparing the cover for actively heating contents of the baby bottle, comprising placing the cover into a heating means, using the heating means to cause the gel to reach the heated state, and then removing the cover from the heating means;
actively heating contents of the baby bottle, comprising fitting the cover over the baby bottle container so that cover conforms to the shape of the baby bottle container and causes the gel to place pressure against a surface of the baby bottle container, positioning the nipple of the baby bottle through the opening of the cover, and allowing the gel in the heated state to transfer heat to the baby bottle;
removing the baby bottle from the cover by pulling the baby bottle away from the cover;
preparing the cover for actively cooling contents of the baby bottle, comprising placing the cover into a cooling means, using the cooling means to cause the gel to reach the chilled state, and then removing the cover from the cooling means;
actively cooling contents of the baby bottle, comprising fitting the cover over the baby bottle container so that cover conforms to the shape of the baby bottle container and causes the gel to place pressure against a surface of the baby bottle container, positioning the nipple of the baby bottle through the opening of the cover, and allowing the gel in the chilled state to transfer heat away from the baby bottle.

22. The method of claim 21, wherein fitting the cover over the baby bottle comprises inserting the baby bottle through a slit in the cover, wherein the slit is formed when a closure mechanism on the cover is unfastened.

23. The method of claim 22, wherein the closure mechanism is a zipper, wherein the cover is substantially cylindrical having a circumference, and wherein the zipper extends about half-way around the circumference of the cover.

24. The method of claim 22, wherein the closure mechanism is a zipper, wherein the cover has a top, a bottom, and a longitudinal side between the top and the bottom, wherein the zipper extends along the longitudinal size of the cover and positioned in a top-down direction.

25. The method of claim 21, wherein the heating means is boiling water.

26. The method of claim 21, wherein the cooling means is a freezer.

27. The method of claim 21, wherein the cover has a top, a bottom, and a longitudinal side, wherein the longitudinal side has an inner surface, wherein the gel covers the entire inner surface.

28. The method of claim 22, wherein the flexible material of the cover is an insulating material that is capable of maintaining the temperature of contents of the baby bottle when the baby bottle container is placed entirely within the cover and the closure mechanism is fastened.

29. The method of claim 21, wherein the gel is secured to the cover by a thin material that is thermally conductive to promote heat transfer between the gel and baby bottle when the baby bottle is placed within the cover and the cover is conformed to the shape of the baby bottle.

30. A method of actively heating and cooling contents of one or more containers, each container having an inner surface and an outer surface, wherein the contents are in contact with a portion of the inner surface, the method comprising:
selecting a sleeve comprising an opening, an inner layer, an outer layer made of an insulating material, and a gel between the inner and outer layer, wherein the outer layer is configured to form a continuous side of the opening, wherein the gel can be chilled by a cooling means and heated by a heating means;
selecting a first container having contents to be cooled;
preparing the sleeve for active cooling contents of the first container by placing the sleeve into a cooling means to chill the gel to a desired chilled temperature, and then removing the sleeve from the cooling means after the gel is chilled to the desired chilled temperature;
actively cooling contents of the first container by inserting the first container into the sleeve through the opening so that the first container is housed within the sleeve and the inner layer of the sleeve contacts an outer surface of the first container allowing the gel to transfer heat away from the first container;
removing the first container from the sleeve;
selecting a second container having contents to be heated;
preparing the sleeve for active heating contents of the second container by placing the sleeve into a heating means to heat the gel to a desired heated temperature, and then removing the sleeve from the heating means after the gel is heated to the desired heated temperature;
actively heating contents of the second container by inserting the second container into the sleeve through the opening so that the second container is housed within the sleeve and the inner layer of the sleeve contacts an outer surface of the second container allowing the gel to transfer heat to the second container.

31. The method of claim 30, wherein the sleeve has a round tubular shape, and wherein the gel is in contact with a surface of the container housed within the sleeve.

32. The method of claim 30, wherein the sleeve is collapsible to a generally flat configuration.

33. The method of claim 30, wherein the first container and the second container are different containers.

34. The method of claim 31, wherein the sleeve has a height of four inches, an outer diameter of three and a quarter inches, and an inner diameter of two and a half inches.

35. The method of claim 32, wherein the sleeve has a height that ranges from two inches to eight inches.

36. A method of actively heating and actively cooling one or more beverage products, the method comprising:
selecting a housing configured to receive a beverage product, wherein the housing is made of an insulating material that forms an outer surface and an inner surface of the housing, the housing having an open end for receiving the beverage product, wherein the inner surface of the housing has a cavity configured to receive and position a gel within the housing, wherein the gel has at least two states, a heated state and a chilled state;
selecting a first beverage product to be heated;
preparing the housing for actively heating the first beverage product, wherein preparing the housing for actively heating comprises placing the housing into a heating means, using the heating means to heat the gel until it reaches the heated state, and then removing the housing from the heating means;
actively heating the beverage product by inserting the first beverage product through the open end of the housing, covering at least a portion of the first beverage product with the housing so that the gel in the heated state is in contact with at least a portion of the first beverage product, and allowing the gel in the heated state to transfer heat to the first beverage product;
removing the first beverage product from the housing by dispensing the first beverage product through the open end of the housing;
selecting a second beverage product to be cooled;
preparing the housing for actively cooling the second beverage product, wherein preparing the housing for actively cooling comprises placing the housing into a cooling means, using the cooling means to chill the gel until the gel reaches the chilled state, and then removing the housing from the cooling means; and
actively cooling the second beverage product, wherein actively cooling comprises inserting the second beverage product through the open end of the housing, covering at least a portion of the second beverage product with the housing so that the gel in the chilled state is in contact with at least a portion of the second beverage product, and allowing the gel in the chilled state to transfer heat away from the second beverage product.

37. The method of claim 36, wherein the cavity for receiving the gel is within the insulating material and formed by a plurality of surfaces of the insulating material.

38. The method of claim 37, wherein the cavity is formed by at least five surfaces of the insulating material.

39. The method of claim 38, wherein the cavity is dimensioned smaller than the gel so that the gel is held in the cavity by compression and the gel is pushed against a beverage product when the beverage product is housed within the housing.

40. The method of claim 36, wherein the first beverage product and the second beverage product are the same beverage product.
